(19) United States
(12) Patent Application Publication
(10) Pub. No.: US 2003/0214970 A1
(43) Pub. Date: Nov. 20, 2003

(54) Method and apparatus for ensuring capability to send information to a wireless device using hybrid network capability

(76) Inventor: Roberto J. Pimentel, Laval (CA)

Correspondence Address: Jonathan P. Osha, Rosenthal & Osha L.L.P., Suite 2800, 1221 McKinney Street, Houston, TX, 77010, US

(21) Appl. No.: 10/147,685

(22) Filed: May 17, 2002

(51) Int. Cl. H04J 3/16

(52) U.S. Cl. 370/465

(57) ABSTRACT

A wireless application gateway for communicating between a wireless device and a backend system includes an application programming interface receiving a mobile-terminated message from the backend system and sending a formatted mobile-originated message to the backend system, a routing layer selecting a first protocol using a characteristic of the mobile-terminated message, a protocol layer generating a formatted mobile-terminated message using the first protocol and generating the formatted mobile-originated message using a second protocol, a transport layer sending the formatted mobile-terminated message to a short message service center and receiving the mobile-originated message, and a configuration file comprising a parameter used to choose the first protocol and the second protocol, wherein the mobile-terminated message is sent to the wireless device using a static identifier of the wireless device and the mobile-originated message is sent to the backend system using a dynamic identifier of the wireless device.

### BACKGROUND OF INVENTION

Mobile professionals, e.g., professionals that travel on business, require a convenient means to access information while away from the office. The information that typically has the greatest demand is contained in applications that handle e-mail, scheduling, etc. To meet this demand, mobile professionals are increasingly using wireless devices, e.g., Personal Digital Assistants (PDA) with wireless capabilities, web-enabled cellular phones, etc., to provide the link between themselves and the applications located in the office.

Wireless devices typically employ either a “pull” framework or “push” framework to connect to the office. Both technologies are based on a client/server model, where the client is a wireless device and the server is a computer located at the office, which is connected to the Internet or other Wide Area Network (WAN). Usually, one computer in the model is a wireless application server, e.g., a server that controls data transfer to and from a wireless device.

Short Message Services (SMS) employs a push framework and a pull framework to send Short Messages (SM's) to a wireless device. An SM may be sent on a control channel and often has a message length of approximately 100 bytes to 500 bytes. FIG. 1 shows a conventional SMS architecture. An SMS center (SMSC) (10) is connected to one or more applications (14). For example, applications such as web-based email may use SMS to send messages to a wireless device (24) A location database (16) is accessed by a switching network (20), which represents one or more entities, such as an authentication center. The location database (16) typically includes a home location register and a visiting location register, which are used to maintain location information on roaming wireless devices.

Base station system 1 (22A), base station system 2 (22B), and base station system N (22N) include entities such as a transceiver and transmitting tower. The wireless device (24), such as a cellular phone, includes necessary functionality for communicating with wireless networks, such as a wireless network interface with a communications stack. The wireless device (24), for authentication purposes, typically includes cryptographic functionality and a Subscriber Identification Module (SIM), which includes a unique identifier such as a serial number. Both Mobile Originated (MO) SM's and Mobile Terminated (MT) SM's may be transferred using the SMS architecture of FIG. 1.

FIG. 2 shows a conventional sequence of operations occurring during transmission of an unsolicited MT SM on a typical SMS architecture. An application, such as a web-based email application submits an MT SM to the SMSC (Step 30). The MT SM has a destination of one or more wireless devices, which are identified by a static identifier (static ID), which is typically an international phone number. The international phone number uniquely identified the wireless device and typically includes up to 16 digits, including a country code, a mobile operator code, and a handset number assigned to the wireless device. The static ID is included as a destination address as part of the MT SM.

When a user submits an SM to be sent as an MT SM to the wireless device, the SM typically begins with the static ID, which is followed by up to 160 characters, which is the text of the SM itself. MT SM's may be sent to the SMSC using a particular SMS protocol, such as Short Message Peer-to-Peer (SMPP) protocol, Computer Interface to Message Distribution (CIMD), etc., over Transmission Control Protocol/Internet Protocol (TCP/IP).

Because SMS has store-and-forward capabilities, the SMSC may send an MT SM to the wireless device via the switching network when the wireless device is located. The SMSC interacts with the switching network to determine the location of the wireless device via the location database. The location database is queried in order to get location information (Step 32). The static ID is used in identifying a wireless device. Generally, an MT SM may be sent to the wireless device if the wireless device is turned on. However, SMS has store-and-forward capabilities, and the SMSC may store the MT SM until the wireless device is available, and then send the MT SM.

Usually, an authentication procedure is initiated for the wireless device (Step 34). A determination is made as to whether the wireless device is authenticated and available (Step 36). If the wireless device is authenticated and available, the MT SM is transferred to the wireless device using the static ID (Step 38). A result of transferring the MT SM (i.e., success or failure) to the wireless device is reported back to the application that sent the MT SM (Step 40). Step 40 is also performed if the wireless device is not authenticated and available in Step 36.

Many wireless carriers provide packet-based wireless services in order to provide Internet Protocol-level (IP-level) connectivity to wireless devices. IP-level communications on a packet-based wireless network usually assign a dynamic identifier (dynamic ID) to a wireless device. Thus IP-level communications provide opportunity for messages longer than 160 bytes. One such packet-based wireless service is a General Packet Radio Service (GPRS) wireless network.

FIG. 3 shows a typical architecture for a GPRS wireless network (49). A Server GPRS Support Node (SGSN) (50) is responsible for communication between the wireless device (24) and the GPRS wireless network (49). Gateway GPRS Support Node 1 (52) and Gateway GPRS Support Node 2 (54) connect the SGSN (50) to Packet Data Network (PDN) 1 (56) and PDN 2 (58), respectively, which are, for example, IP networks (such as the Internet or an intranet), or an X.25 network. An SMSC (10) sends and receives SM's from and to applications (14). Routing information is available from the location database (16). Base station system 1 (22A), base station system 2 (22B), and base station system N (22N) include entities such as a transceiver and transmitting tower. When the wireless device (24) is attached to the GPRS wireless network (49), packets may be transferred to and from the wireless device (24) via the GGSN 1 (52) or GGSN 2 (54) using a dynamic identifier, such as an IP number assigned to the wireless device (24), via, for example, via Dynamic Host Configuration Protocol (DHCP).

FIG. 4 shows a typical sequence of operations for attaching a wireless device to a GPRS wireless network for IP-level communications, thus enabling two-way IP-level communication to and from the wireless device via the wireless network. The wireless device requests to attach to the GPRS wireless network (Step 70). The wireless device requests to attach to the GPRS wireless network when the wireless device is initially powered on. After attachment, an authentication procedure for the wireless device is initiated (Step 72). Authentication involves accessing uniquely identifying information stored on the wireless device in order to verify that the wireless device is authorized to access the GPRS wireless network.

A determination is made as to whether the wireless device is authenticated (Step 74). If the wireless device is not authenticated, the sequence ends. Otherwise, a dynamic ID (e.g., an IP number) is assigned to the wireless device (Step 76). Once the wireless device is attached to the GPRS wireless network, two-way IP-level communications between the GPRS wireless network and applications on packet data networks attached to the GPRS wireless network may commence (Step 78).

For example, a web-based email application may send an unsolicited email to the wireless device, and the wireless device may respond. The wireless device may also send unsolicited messages to applications on a packet data network. Other operations not shown in FIG. 4 may also occur. For example, the wireless device may roam to other areas and send location updates. The wireless device is detached from the GPRS wireless network via one or more possible mechanisms, such powering off the wireless device or leaving a particular geographic area covered by the GPRS wireless network (Step 80).

### SUMMARY OF INVENTION

In general, in one aspect, the invention relates to a wireless application gateway for communicating between a wireless device and a backend system. The wireless application gateway comprises an application programming interface receiving a mobile-terminated message from the backend system and sending a formatted mobile-originated message to the backend system, a routing layer selecting a first protocol using a characteristic of the mobile-terminated message, a protocol layer generating a formatted mobile-terminated message using the first protocol and generating the formatted mobile-originated message using a second protocol, a transport layer sending the formatted mobile-terminated message to a short message service center and receiving the mobile-originated message, and a configuration file comprising a parameter used to choose the first protocol and the second protocol, wherein the mobile-terminated message is sent to the wireless device using a static identifier of the wireless device and the mobile-originated message is sent to the backend system using a dynamic identifier of the wireless device.

In general, in one aspect, the invention relates to a method for sending a mobile-terminated message to a wireless device. The method comprises sending the mobile-terminated message from a backend system to a wireless application gateway, choosing a protocol using a characteristic of the mobile-terminated message, generating a formatted mobile-terminated message by the wireless application gateway using the protocol, and sending the formatted mobile-terminated message to the wireless device using an identifier of the wireless device.

In general, in one aspect, the invention relates to a method for sending a mobile-originated message from a wireless device to a backend system. The method comprises sending the mobile-originated message from the wireless device to a wireless application gateway using an identifier of the wireless device, choosing a protocol using a characteristic of the mobile-originated message, generating a formatted mobile-originated message by the wireless application gateway using the protocol, and sending the formatted mobile-originated message to the backend system.

In general, in one aspect, the invention relates to a method for sending a mobile-originated message from a wireless device to a backend system. The method comprises sending the mobile-originated message from the wireless device to a wireless application gateway using an identifier of the wireless device, choosing a protocol using a characteristic of the mobile-originated message, generating a formatted mobile-originated message using the protocol, sending the formatted mobile-originated message to the backend system, attaching the wireless device to a wireless network, authenticating the wireless device, assigning the dynamic identifier to the wireless device if the wireless device is authenticated, and choosing the protocol using a configuration parameter.

In general, in one aspect, the invention relates to an apparatus for sending a mobile-terminated message to a wireless device. The apparatus comprises means for sending the mobile-terminated message from a backend system to a wireless application gateway, means for choosing a protocol using a characteristic of the mobile-terminated message, means for generating a formatted mobile-terminated message by the wireless application gateway using the protocol, and means for sending the formatted mobile-terminated message to the wireless device using an identifier of the wireless device.

In general, in one aspect, the invention relates to an apparatus for sending a mobile-originated message from a wireless device to a backend system. The apparatus comprises means for sending the mobile-originated message from the wireless device to a wireless application gateway using an identifier of the wireless device, means for choosing a protocol using a characteristic of the mobile-originated message, means for generating a formatted mobile-originated message by the wireless application gateway using the protocol, and means for sending the formatted mobile-originated message to the backend system.

Other aspects and advantages of the invention will be apparent from the following description and the appended claims.

### BRIEF DESCRIPTION OF DRAWINGS

FIG. 1 shows a typical SMS architecture.

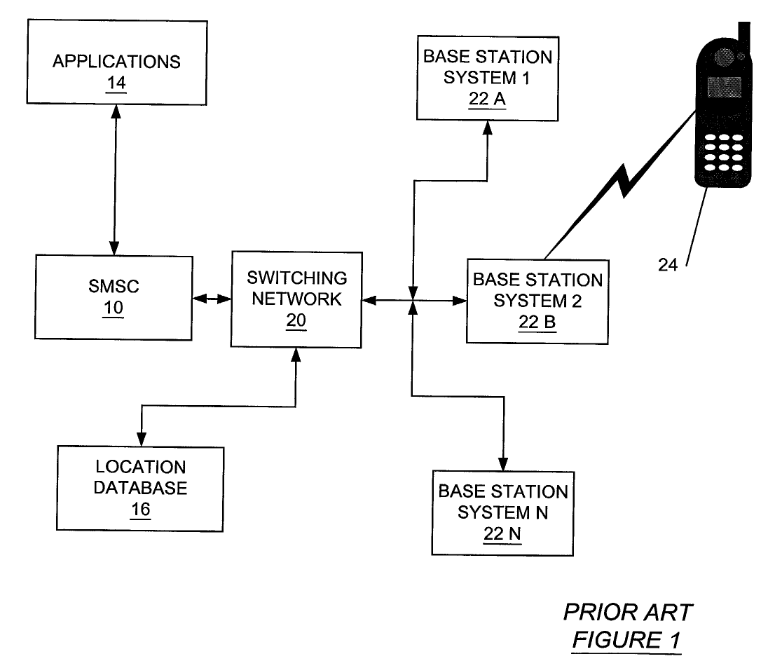

FIG. 2 shows a sequence of operations occurring during transmission of a an unsolicited Mobile Terminated (MT) Short Message (SM) on a typical Short Message Service (SMS) architecture.

FIG. 3 shows a typical General Packet Radio Service (GPRS) wireless network architecture.

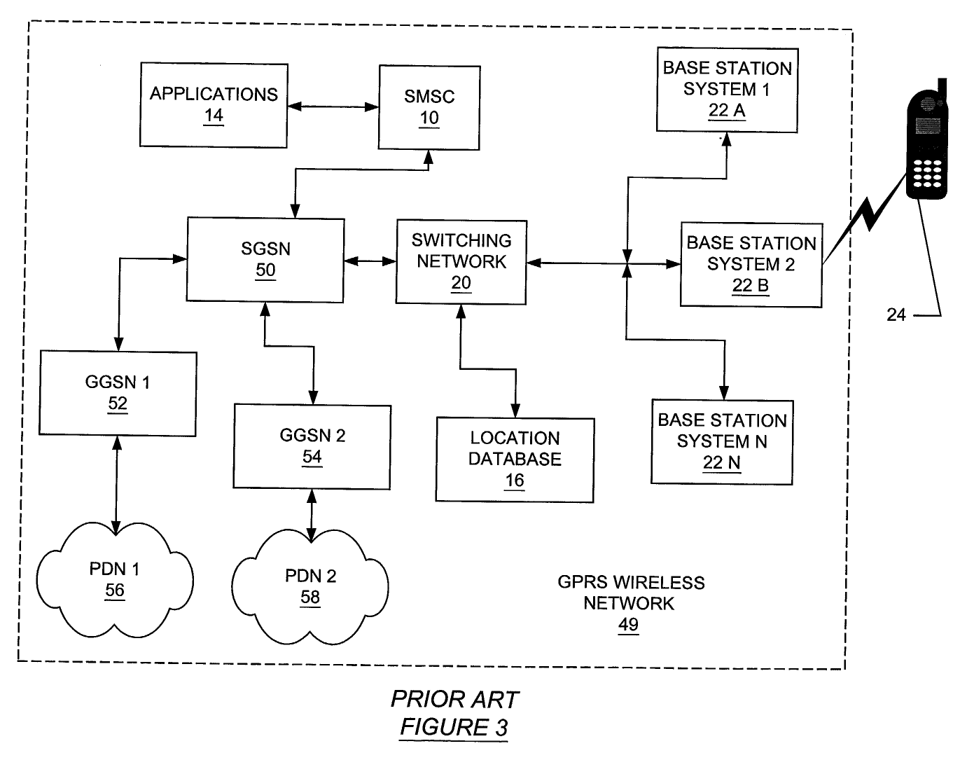

FIG. 4 shows a typical sequence of operations for attaching a wireless device to a GPRS wireless network for Internet Protocol (IP)-level communications.

FIG. 5 shows, in accordance with one or more embodiments of the present invention, a messaging system employing a hybrid addressing scheme.

FIG. 6 shows, in accordance with one or more embodiments of the present invention, a Wireless Access Gateway (WAG).

FIG. 7 shows, in accordance with one or more embodiments of the present invention, a sequence of operations to send an MT SM from a backend system using a static Identifier (ID) of a wireless device and send an Mobile Originated (MO) message to the backend system using a dynamic ID of the wireless device.

### DETAILED DESCRIPTION

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

A hybrid addressing scheme is used as part of a messaging system in order to enable a backend system to send unsolicited MT messages (such as a push SM) to a wireless device (such as a cellular phone) using a static ID of the wireless device. The backend system may, in accordance with one or more implementations of the invention, be an enterprise system, i.e., a backend system with multiple integrated networks running on various platforms and operating systems in more than one physical location. The hybrid addressing scheme is also used by the backend system to enable reception of MO messages (such as web page requests) from the wireless device using a dynamic ID (such as an IP number) assigned to the wireless device by a wireless network.

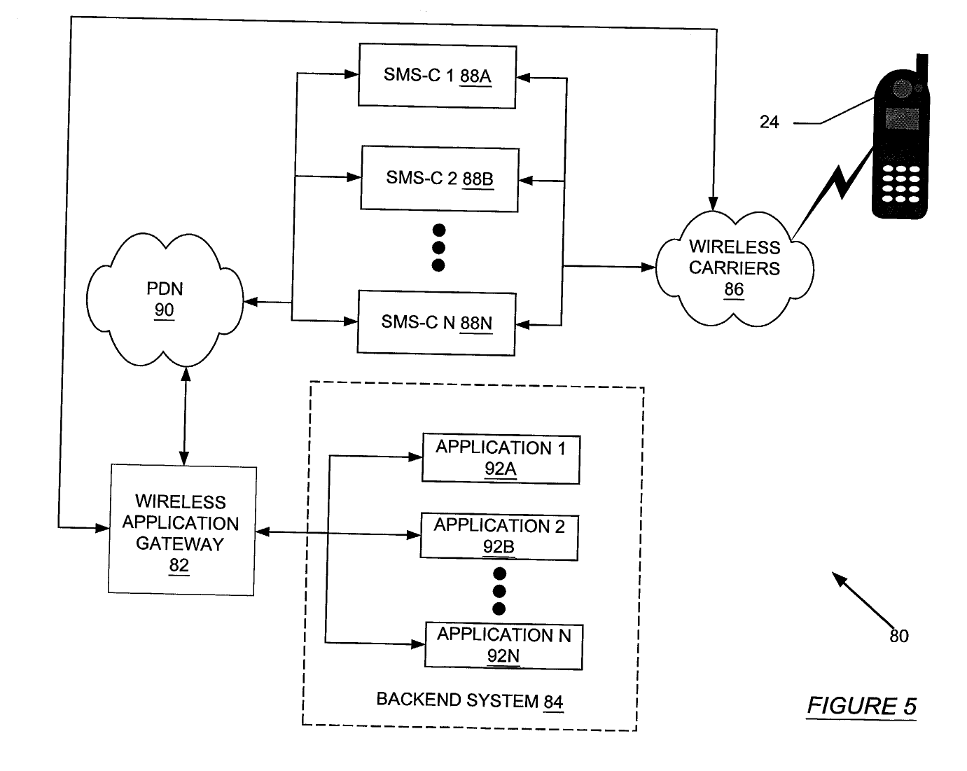

The messaging system (80), as shown in FIG. 5, includes a Wireless Access Gateway (WAG) (82) that provides a backend system (84) an access point to one or more wireless carriers (86) and messaging services (e.g., SMS) via SMSC 1 (88A), SMSC 2 (88B), and SMSC N (88N). The wireless carriers may include, for example, a GPRS wireless network. The wireless carriers (86) are connected to the WAG (82) via a Packet Data Network (PDN) (90) over a packet-switched protocol, such as TCP/IP or X.25. MT messages may be sent from an application (such as application 1 (92A), application 2 (92B), or application N (92N)) of the backend system (84) to the wireless device (24). MO messages may be sent from the wireless device (24) as IP-level communications via the PDN (90) or as an SM via SMSC 1 (88A), SMSC 2 (88B), and SMSC N (88N). Those skilled in the art will realize that, in accordance with one or more embodiments of the invention, other entities may be included in FIG. 5, such as a firewall, location databases, etc.

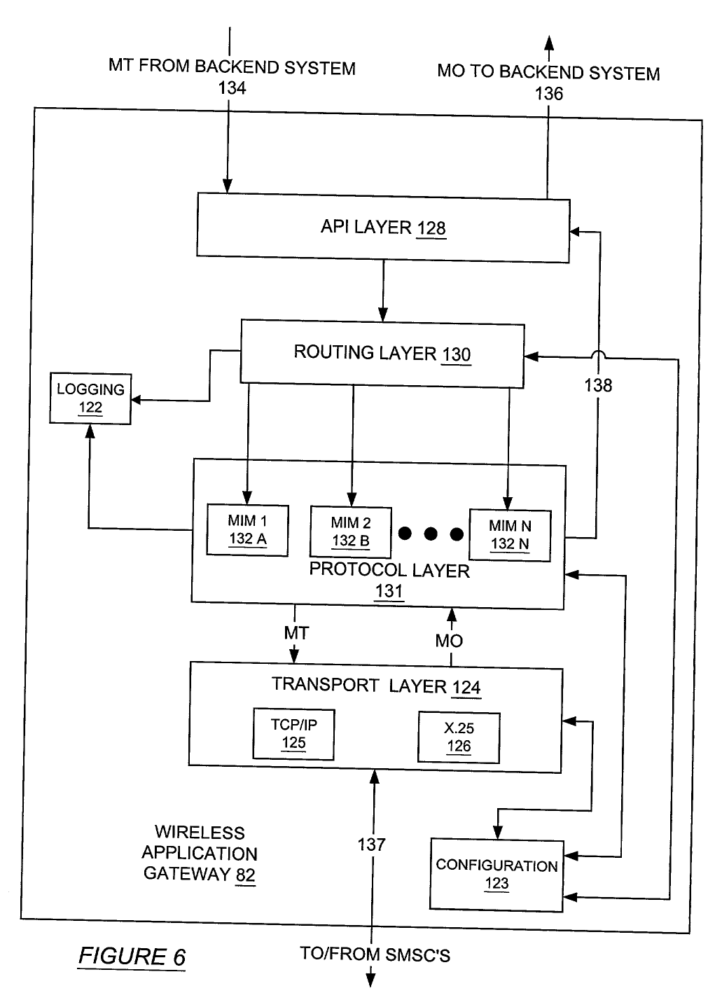

The WAG (82) is shown in detail in FIG. 6. A logging module (122) provides a unified, centralized mechanism for logging text strings to one or more files, and is used by other components of the WAG (82). A configuration module (123) provides a unified, centralized mechanism for handling configuration files to ensure consistency for configuration needs of components of the WAG. A transport layer (124) offers a transport abstraction for communications with different SMSC's by providing support for TCP/IP and X.25 connections with a TCP/IP module (125) and a X.25 module (126). The transport layer (124) provides a common unified Application Programming Interface (API) so that upper layers of the WAG (82) are able to communicate with different SMSC's.

An API layer (128) makes available to external applications (e.g., application 1 (92A), application 2 (92B), etc., of FIG. 5) methods of interfaces and classes for sending MT messages to the wireless device. For example, an SMS class may have a SendMsg( ) method that may be invoked by an application with an argument list that includes an international phone number of a wireless device to receive an MT message that is a push SM.

A routing layer (130) implements routing of MT messages and MO messages and, in accordance with one or more embodiments of the invention, provides load-balancing services. The routing layer (130) provides capability to select a Messaging Interface Module (MIM) of a protocol layer (131). The protocol layer (131) includes an MIM corresponding to each messaging protocol required by a particular SMSC. For example, SMSC 1 (92A), as shown in FIG. 5, may require that an SM use a Standard Context Routing (SCR) messaging protocol, and SMSC 2 (92B) may require a Short Message Peer to Peer (SMPP) messaging protocol. MIM 1 (132A), MIM 2 (132B), and MIM N (132N) handle formatting of SM's for a particular messaging protocol. For example, MIM 2 (132B) may format an MT SM according to the SMPP messaging protocol. One or more of MIM 1 (132A), MIM 2 (132B), and MIM N (132N) may also, in accordance with one or more embodiments of the invention format communications using an User Datagram Protocol/Internet Protocol. MO Messages incoming from a wireless device to the backend system are routed using the routing layer (130). One of two attributes of an MO message is used to route the MO message to an application of the backend system: an originating address of a packet of the MO message, or a destination address of the packet of the MO message.

MT's from the backend system enter the WAG (82) via a WAG input line (134), and MO's destined for the backend system leave the WAG (82) via an WAG output line (136). Formatted MT's sent to SMSC's and MO's relayed from SMSC's or a PDN enter the WAG (82) via a WAG-PDN link (137). Formatted MO's, results of MT SM's (i.e., success or failure of an MT SM to reach the wireless device (24)) and alarms, etc., are sent from the protocol layer (131) to the API layer (128) via a formatted MO path (138). Those skilled in the art will realize that, in one or more embodiments of the invention, FIG. 6 may include a lesser or greater number of entities than as discussed above.

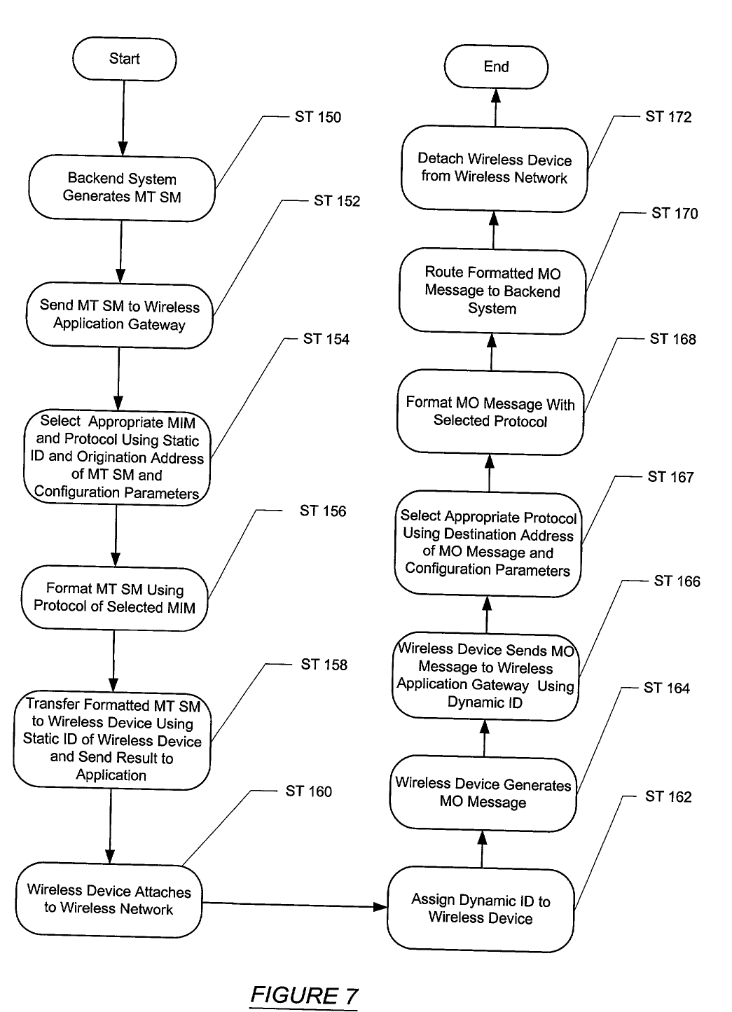

FIG. 7 shows a sequence of operations to send an MT SM from the backend system using a static ID of the wireless device and send an MO message to the backend system using a dynamic ID of the wireless device. An application of the backend system generates the MT SM (Step 150), and sends the MT SM to the WAG (Step 152) using an API provided by the API layer. The routing layer selects an appropriate MIM (and protocol corresponding to the selected MIM) using a characteristic of the MT SM and configuration parameters (Step 154). The MT SM includes the static ID of the wireless device and the originating address of the application. The routing layer examines the MT SM to determine the originating address and static ID, and uses the originating address and static ID, together with the configuration parameters to determine which MIM (and corresponding protocol) to select in order to format the MT SM. The configuration parameters are accessed from the configuration module when the WAG is initialized. The routing layer provides routing logic to route the MT SM to a selected MIM.

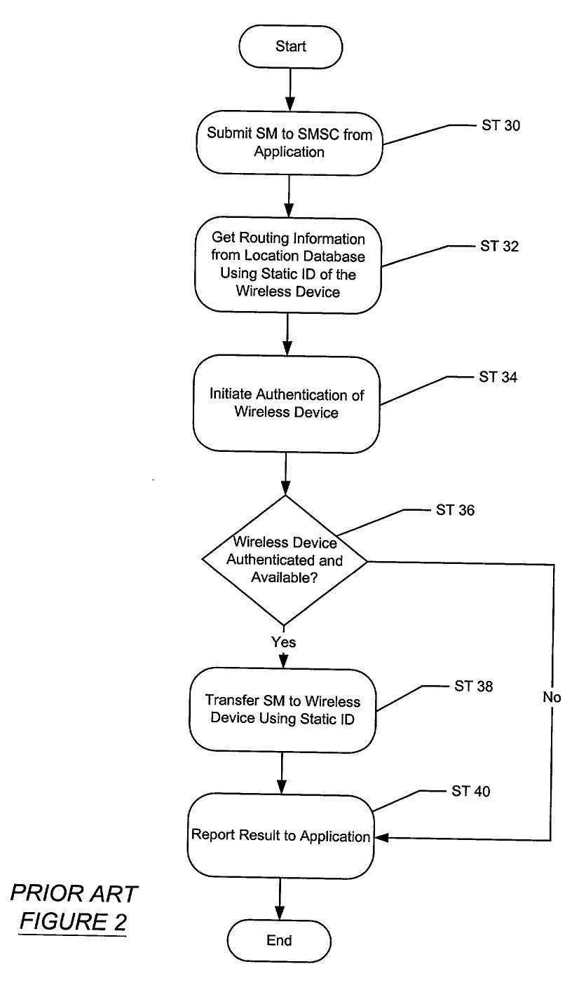

The MT SM is formatted by the protocol of the selected MIM (Step 156). For example, the selected MIM may format the MT SM using the SMPP protocol in preparation for sending the MT SM to a particular SMSC. A formatted MT SM is transferred to the wireless device using the static ID of the wireless device, and the result of the transfer is sent back to the application (Step 158). Transferring the formatted MT SM involves sending the formatted MT SM to an appropriate SMSC using an API of the transport layer and using standard SMS techniques as shown in FIG. 2 to send the formatted MT SM to the wireless device. A result of the transfer of the MT SM (i.e., success or failure) is routed back to the application as a code. The result is routed through the transport layer, the protocol layer, and the formatted MO path as shown in FIG. 6.

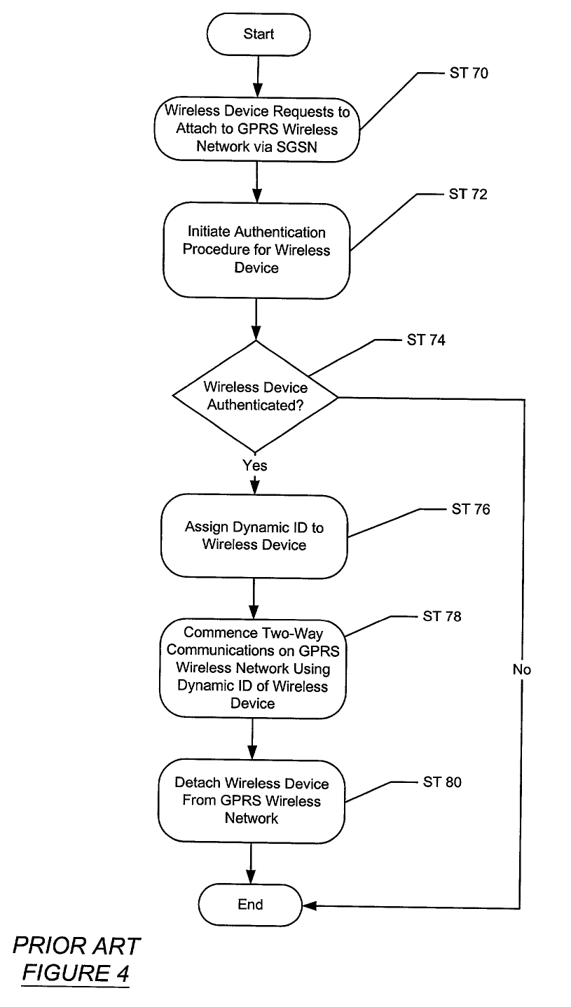

As a result of receiving the MT SM, a user of the wireless device may decide to attach to a wireless network, such as a GPRS wireless network (Step 160). Standard attach operations, such as shown in FIG. 4, may be used to attach to the GPRS wireless network. A dynamic ID, such as an IP number, is assigned to the wireless device (Step 162).

The wireless device generates an MO message to send to the backend system (Step 164). For example, the MT SM received by the wireless device may include a Uniform Resource Locator (URL), e.g., a web page, that the user, after reading, may wish to download and browse, using a web browser included on the wireless device. The MO message, for such a case, is a request for a web page. The wireless device sends the MO message (which may, in one or more embodiments of the invention, be a UDP request) to the WAG using the dynamic ID of the wireless device (Step 166).

The WAG uses the destination address of the MO message and the configuration parameters to select a protocol (Step 167). A selected protocol is used to format the MO message to generate a formatted MO message (Step 168). The formatted MO message is routed to the backend system via the formatted MO path and the API layer (Step 170). Optionally, application-level authentication may be implemented by the backend server. For example, the user may be required to enter a Personal Identification Number (PIN) in order to access the web page. When the user has completed communications, the wireless device detaches from the GPRS wireless network (Step 172).

Those skilled in the art will realize that, in one or more embodiments of the invention, the operations shown in FIG. 7 may differ. For example, the MO message may be sent from the backend system to a host located in a different network, such as another wireless device attached a distant network. Furthermore, the MO message may employ a different communications channel than shown in FIG. 7. For example, the MO message may be an SM, or may use another protocol other than UDP. Also, MT messages may be MT SM's or may be IP-level communications, if the wireless device has been assigned a static IP address by a wireless network.

In order to provide for consistency to both application layers on the wireless device and on the application, SMS services may, in one or more embodiments of the invention, employ an IP interface to provision for UDP/IP services.

Advantages of the present invention may include one or more of the following. The invention provides functionality for ensuring that an unsolicited communication is sent from a backend system to a wireless device (even if the wireless device does not presently have a dynamic address), while also providing functionality for the wireless device to communicate with the backend system using IP-level communication, or any other available channel. The invention provides functionality for handling possible disparities among many possible wireless network addressing schemes, thus providing a consistent, unique interface to the backend system.

The invention enhances security by alleviating need for server-initiated IP-level access because a push SM does not rely on widely-accessible IP-level communications. The invention enhances user experience because a push SM may be sent to the user when the wireless device is powered down, stored and then forwarded when the wireless device is powered up. The invention provides a cost savings by alleviating a need for GPRS inter-carrier roaming infrastructure because a user may benefit from existing SM inter-carrier roaming infrastructure already in place.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A wireless application gateway for communicating between a wireless device and a backend system, comprising:
an application programming interface receiving a mobile-terminated message from the backend system and sending a formatted mobile-originated message to the backend system;
a routing layer selecting a first protocol using a characteristic of the mobile-terminated message;
a protocol layer generating a formatted mobile-terminated message using the first protocol and generating the formatted mobile-originated message using a second protocol;
a transport layer sending the formatted mobile-terminated message to a short message service center and receiving the mobile-originated message; and
a configuration file comprising a parameter used to choose the first protocol and the second protocol;
wherein the mobile-terminated message is sent to the wireless device using a static identifier of the wireless device and the mobile-originated message is sent to the backend system using a dynamic identifier of the wireless device.

2. The wireless application gateway of claim 1, the mobile-terminated message comprising a short message.

3. The wireless application gateway of claim 1, the mobile-originated message comprising a user datagram protocol request.

4. The wireless application gateway of claim 1, the characteristic comprising an originating address of the mobile-terminated message.

5. The wireless application gateway of claim 1, the characteristic comprising the static identifier of the wireless device.

6. The wireless application gateway of claim 1, wherein the second protocol is chosen using a characteristic of the mobile-originated message.

7. The wireless application gateway of claim 6, the characteristic comprising a destination address of the mobile-originated message.

8. A method for sending a mobile-terminated message to a wireless device, comprising:
sending the mobile-terminated message from a backend system to a wireless application gateway;
choosing a protocol using a characteristic of the mobile-terminated message;
generating a formatted mobile-terminated message by the wireless application gateway using the protocol; and
sending the formatted mobile-terminated message to the wireless device using an identifier of the wireless device.

9. The method of claim 8, the identifier comprising a dynamic identifier.

10. The method of claim 8, the identifier comprising a static identifier.

11. The method of claim 10, the static identifier comprising an international telephone number.

12. The method of claim 8, the characteristic comprising the static identifier.

13. The method of claim 8, the characteristic comprising an origination address of the mobile-terminated message.

14. The method of claim 8, wherein the mobile-terminated message is a short message.

15. The method of claim 8, further comprising:
reading a configuration parameter from a configuration file of the wireless application gateway;
choosing the protocol using the configuration parameter.

16. A method for sending a mobile-originated message from a wireless device to a backend system, comprising:
sending the mobile-originated message from the wireless device to a wireless application gateway using an identifier of the wireless device;
choosing a protocol using a characteristic of the mobile-originated message;
generating a formatted mobile-originated message by the wireless application gateway using the protocol; and
sending the formatted mobile-originated message to the backend system.

17. The method of claim 16, the mobile-originated message comprising a user datagram protocol request.

18. The method of claim 16, the characteristic comprising a destination address of the mobile-originated message.

19. The method of claim 16, the identifier comprising a static identifier.

20. The method of claim 16, the identifier comprising a dynamic identifier.

21. The method of claim 20, the dynamic identifier comprising an internet protocol address.

22. The method of claim 16, further comprising:
attaching the wireless device to a wireless network;
authenticating the wireless device; and
assigning the dynamic identifier to the wireless device if the wireless device is authenticated.

23. The method of claim 16, further comprising:
choosing the protocol using a configuration parameter.

24. A method for sending a mobile-originated message from a wireless device to a backend system, comprising:
sending the mobile-originated message from the wireless device to a wireless application gateway using an identifier of the wireless device;
choosing a protocol using a characteristic of the mobile-originated message;
generating a formatted mobile-originated message using the protocol;
sending the formatted mobile-originated message to the backend system;
attaching the wireless device to a wireless network;
authenticating the wireless device;
assigning the dynamic identifier to the wireless device if the wireless device is authenticated; and
choosing the protocol using a configuration parameter.

25. An apparatus for sending a mobile-terminated message to a wireless device, comprising:
means for sending the mobile-terminated message from a backend system to a wireless application gateway;
means for choosing a protocol using a characteristic of the mobile-terminated message;
means for generating a formatted mobile-terminated message by the wireless application gateway using the protocol; and
means for sending the formatted mobile-terminated message to the wireless device using an identifier of the wireless device.

26. The apparatus of claim 25, the identifier comprising a dynamic identifier.

27. The apparatus of claim 25, the identifier comprising a static identifier.

28. An apparatus for sending a mobile-originated message from a wireless device to a backend system, comprising:
means for sending the mobile-originated message from the wireless device to a wireless application gateway using an identifier of the wireless device;
means for choosing a protocol using a characteristic of the mobile-originated message;
means for generating a formatted mobile-originated message by the wireless application gateway using the protocol; and
means for sending the formatted mobile-originated message to the backend system.

29. The apparatus of claim 28, the identifier comprising a dynamic identifier.

30. The apparatus of claim 28, the identifier comprising a static identifier.
